(19) United States
(12) Patent Application Publication
(10) Pub. No.: US 2012/0112448 A1
(43) Pub. Date: May 10, 2012

(54) DETACHABLE BOOK STRUCTURE

(76) Inventors: Kuo-Hung Lo, Taipei City (TW); Shu-Ping Huang, Taipei City (TW)

(21) Appl. No.: 12/943,023

(22) Filed: Nov. 10, 2010

(51) Int. Cl. B42D 1/00

(52) U.S. Cl. 281/15.1

(57) ABSTRACT

The present invention is related to a detachable book structure which mainly comprises a plurality of mounting elements provided on an inner side of an outer cover plate and edges of a plurality of books. Thus, the plurality of books can be stably mounted in the outer cover plate by the mounting elements, so as to carry out the purpose of detaching at least one of the books according to desire.

### FIELD OF THE INVENTION

The present invention relates to a detachable book structure, and more particularly to a book structure capable of detaching at least one of books according to desire.

### BACKGROUND OF THE INVENTION

Generally, foreign language books, textbooks, special books and etc. not only have greater volume and weight than that of normal books, but also are relatively thicker than the normal books. Thus, except for inconveniently carrying a thick book, it is also difficult for a user to read and flip considerable pages of the thick book. After the thick book is flip for a long time, connection portions of the pages stapled and adhered to the thick book will become loose. Finally, the pages are gradually separated from the thick book. In addition, the book carried by the user generally only has a certain portion of pages useful for the user each time. For example, for a textbook, a course generally only needs a single chapter or a few of paragraphs on the day. Nevertheless, the student still needs to carry the whole textbook. If there are many different courses on the day, the student must carry many different textbooks and it thus causes a loading to the student.

As a result, it is important for the man skilled in the art to think how to develop an improved book structure to solve the problems existing in the conventional book structures, as described above.

### SUMMARY OF THE INVENTION

A primary object of the present invention is to provide a detachable book structure, which mainly comprises a plurality of mounting elements provided on an inner side of an outer cover plate and edges of a plurality of books, wherein the plurality of books can be stably mounted in the outer cover plate by the mounting elements, so as to carry out the purpose of detaching at least one of the books according to desire.

### DESCRIPTION OF THE DRAWINGS

FIG. 1 is a perspective view of an appearance of a detachable book structure of the present invention;

FIG. 2 is an exploded perspective view of the detachable book structure according to the present invention;

FIG. 3 is an operational view of the detachable book structure according to a preferred embodiment of the present invention;

FIG. 4 is a first schematic view of the detachable book structure according to another preferred embodiment of the present invention;

FIG. 5 is a second schematic view of the detachable book structure according to another preferred embodiment of the present invention;

FIG. 6 is a third schematic view of the detachable book structure according to another preferred embodiment of the present invention;

FIG. 7 is a fourth schematic view of the detachable book structure according to another preferred embodiment of the present invention;

FIG. 8 is a first schematic view of the detachable book structure according to still another preferred embodiment of the present invention;

FIG. 9 is a second schematic view of the detachable book structure according to still another preferred embodiment of the present invention; and

FIG. 10 is a third schematic view of the detachable book structure according to still another preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

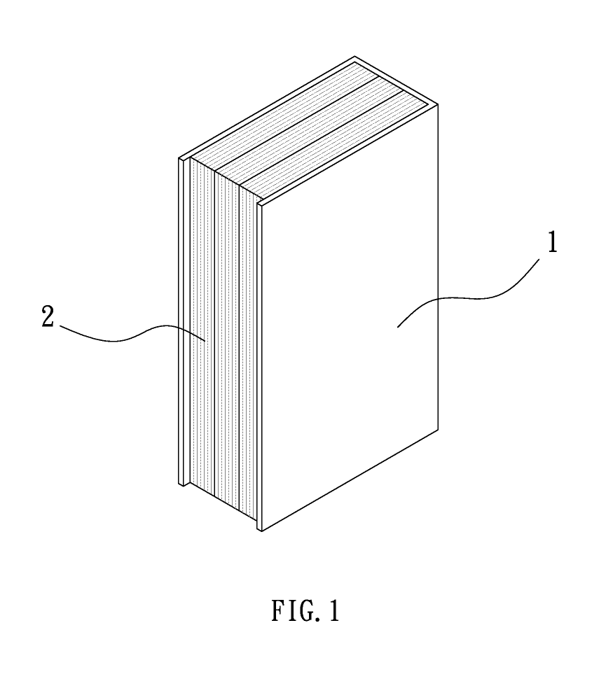

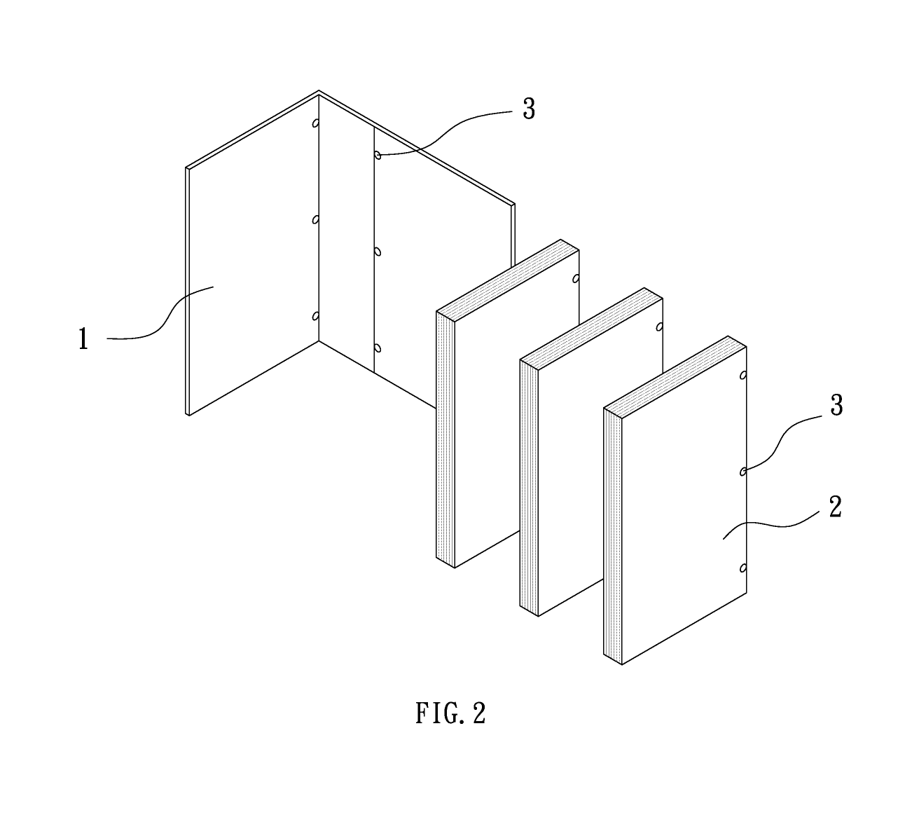

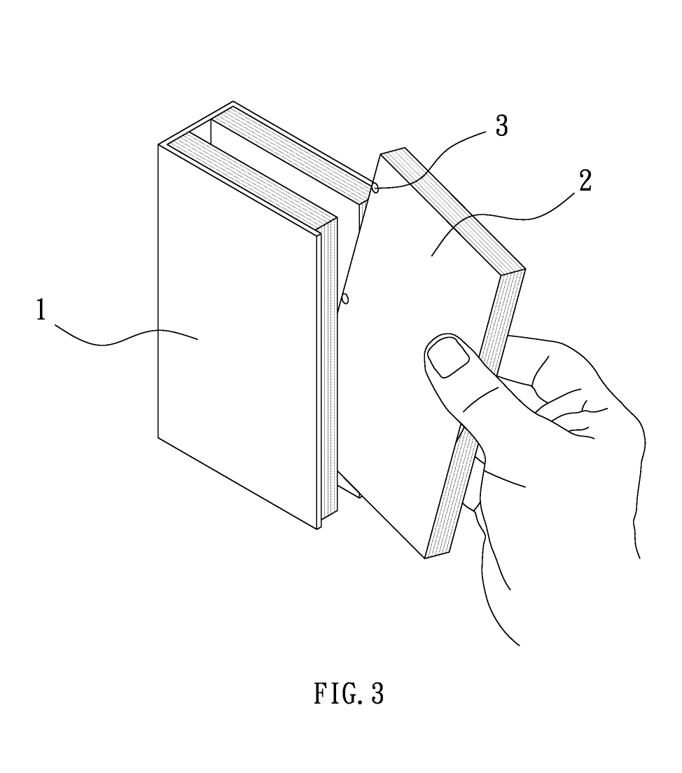

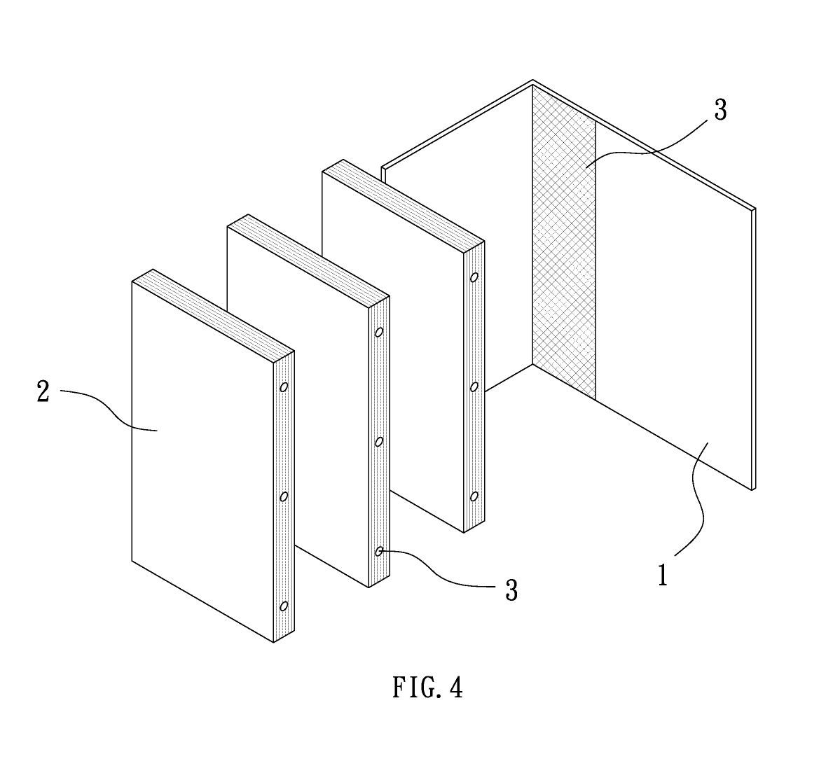

Referring now to FIGS. 1, 2, 3, 4, 5, 6 and 7, a perspective appearance view, an exploded perspective view, a preferred embodiment and another preferred embodiment of the present invention are illustrated. As shown, a detachable book structure comprises:
an outer cover plate 1;
a plurality of books 2 disposed in the outer cover plate 1; and
a plurality of mounting elements 3 provided on an inner side of the outer cover plate 1 and folded edges of each of the books 2, respectively;

wherein the folded edges of each of the books 2 and the inner side of the outer cover plate 1 are provided with the plurality of the mounting elements 3, while positions of the mounting elements 3 of the outer cover plate 1 are corresponding to that of the mounting elements 3 of the books 2. As shown in FIG. 2, the mounting elements 3 are selected from magnetic elements. Thus, when the books 2 are correctly mounted in the outer cover plate 1, a magnetic attractive force will be generated between the mounting elements 3 (magnetic elements) of any two of the adjacent books 2, so that all of the books 2 can be combined into a single combined book. Meanwhile, the mounting elements 3 of the outermost two books 2 of the combined book can be magnetically attracted with the mounting elements 3 (magnetic elements) on the inner side of the outer cover plate 1. As a result, the books 2 can be stably mounted in the outer cover plate 1. Because the outer cover plate 1 and the books 2 are connected to each other by the magnetic attractive force of the mounting elements 3 (magnetic elements), the user can selectively detach some books 2 from the outer cover plate 1 according to the user's desire/needs. Furthermore, except for the arrangement of FIG. 2 that the mounting elements 3 (magnetic elements) are locally provided on specific points, the book structure also can be arranged as shown FIG. 4, wherein one mounting element 3 is locally provided on a specific region in the inner side of the outer cover plate 1, and a plurality of mounting elements 3 are correspondingly provided on the edge surfaces of the books. Thus, the mounting elements 3 on the edge surfaces of the books 2 can be magnetically attracted with the mounting element 3 on the local region in the inner side of the outer cover plate 1, so that the books 2 can be stably mounted in the outer cover plate 1.

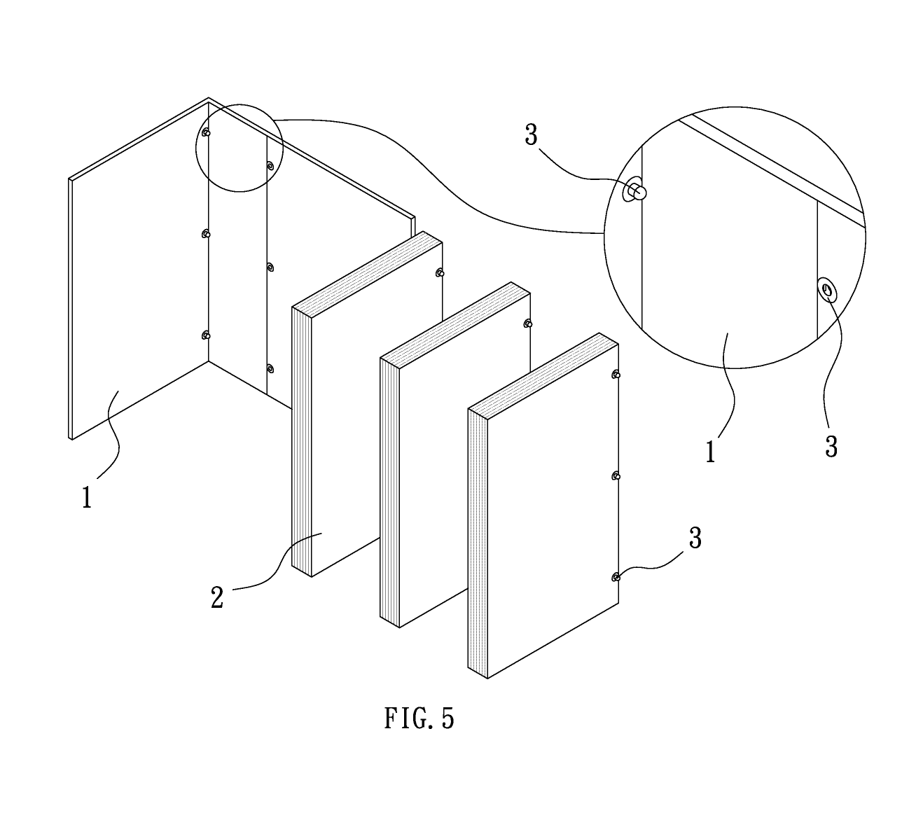

Except for the foregoing magnetic elements, the mounting elements 3 also can be riveting buckles as shown in the design of FIG. 5, wherein the mounting elements 3 (i.e. riveting buckles) are correspondingly provided on the inner side of the outer cover plate 3 and the edges of each of the books 2. When the books 2 are mounted in the outer cover plate 3, the mounting elements 3 (riveting buckles) on the edges of each of the books 2 can be fastened to each other, so that all of the books 2 can be combined into a single combined book. Meanwhile, the mounting elements 3 (riveting buckles) of the outermost two books 2 of the combined book can be fastened to the mounting elements 3 (riveting buckles) on the inner side of the outer cover plate 1. As a result, the books 2 can be stably mounted in the outer cover plate 1, and the user can selectively detach some books 2 from the outer cover plate 1 according to the user's desire/needs.

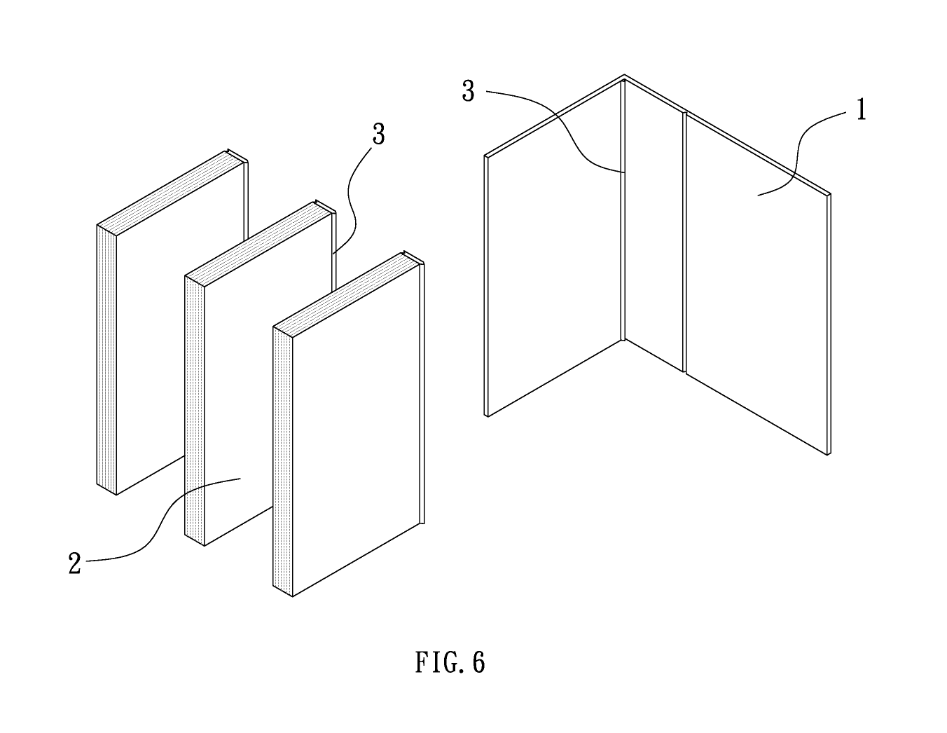

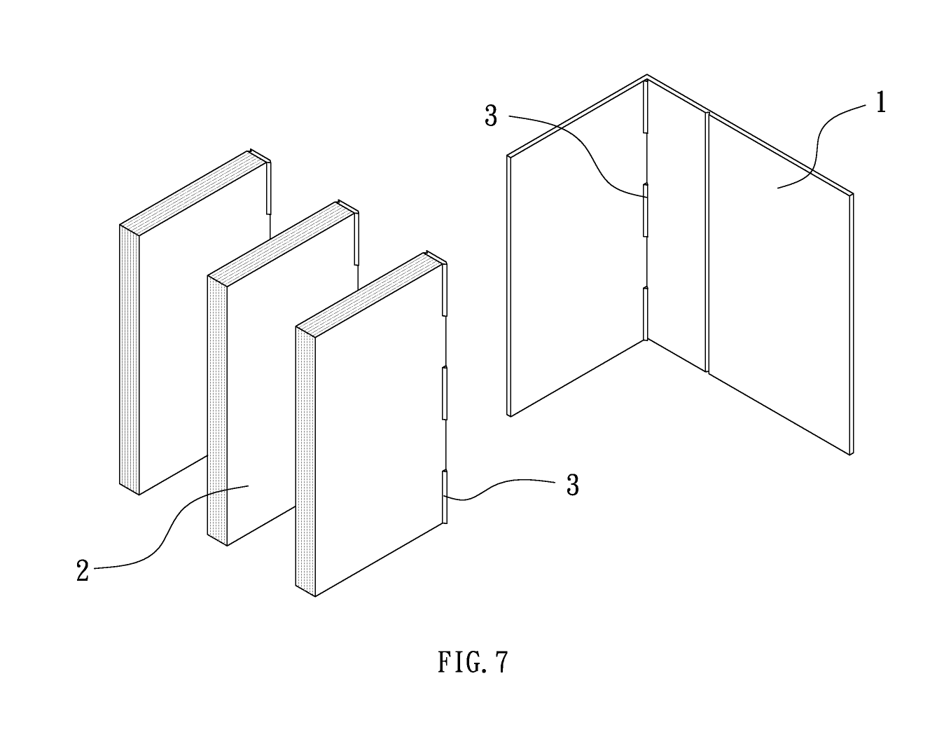

Alternatively, the mounting elements 3 also can be tracks as shown in the design of FIG. 6, wherein the mounting elements 3 (i.e. tracks) are correspondingly provided on the inner side of the outer cover plate 3 and the edges of each of the books 2. When the mounting elements 3 (tracks) on the edges of each of the books 2 are inserted into and engaged with each other, so that all of the books 2 can be combined into a single combined book. Meanwhile, the mounting elements 3 (tracks) of the outermost two books 2 of the combined book can be inserted into and engaged with the mounting elements 3 (tracks) on the inner side of the outer cover plate 1. As a result, the books 2 can be stably mounted in the outer cover plate 1, and the user can selectively detach some books 2 from the outer cover plate 1 according to the user's desire/needs. Except for the foregoing whole tracks as shown in the design of FIG. 6, the mounting elements 3 also can be a plurality of discontinuous track segments as shown in the design of FIG. 7, wherein the difference between the designs of FIG. 6 and FIG. 7 is that the operation of insertion and engagement of the books 2 is different from each other, i.e. the mounting elements 3 (i.e. whole tracks) of FIG. 6 must be directly inserted into each other from a top side or a lower side of the outer cover plate 1, but the mounting elements 3 (i.e. discontinuous track segments) of FIG. 7 can be directly inserted into each other in the outer cover plate 1.

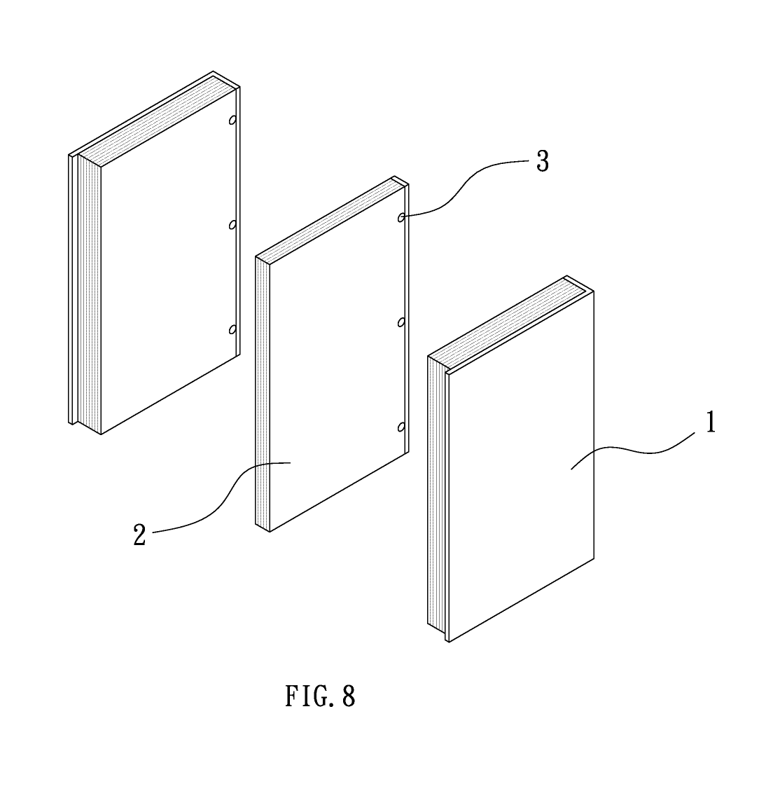

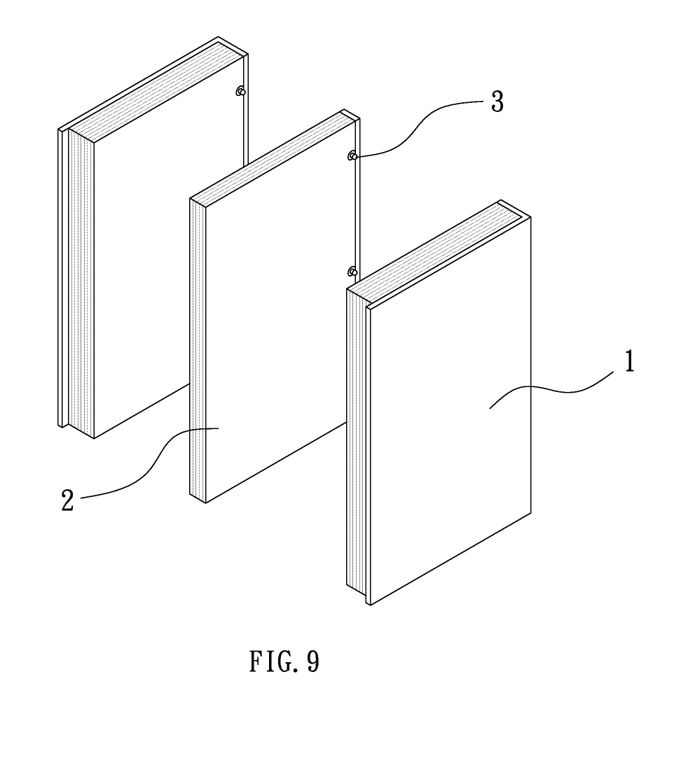

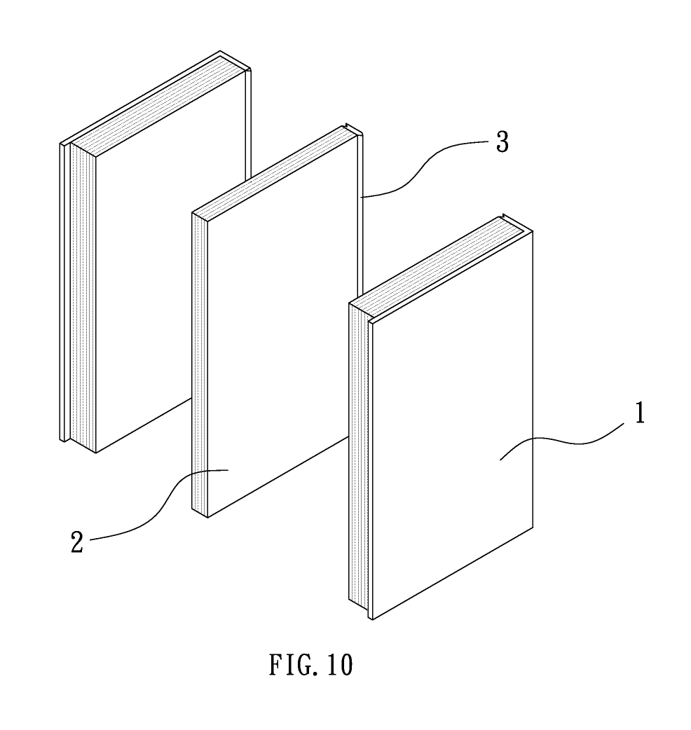

Referring now to FIGS. 8, 9 and 10, a still another preferred embodiment of the present invention is illustrated. As shown, a detachable book structure comprises:
a plurality of books 2, wherein the outermost two sides of the outermost two books 2 is provided with an outer cover plate 1, respectively; and
a plurality of mounting elements 3 provided on folded edges of each of the books 2, respectively;

wherein outer sides of each of the books 2 are provided with the plurality of the mounting elements 3, while positions of the mounting elements 3 of any two adjacent of the books 2 are corresponding to each other. Thus, after all of the books 2 are combined with each other, the books 2 are combined into a single whole combined book, wherein the mounting elements 3 can be selected from magnetic elements, riveting buckles, whole tracks or discontinuous track segments, so that the mounting elements 3 can provide magnetic attractive force of the magnetic elements, fastening of the riveting buckles, insertion and engagement of the whole tracks or the discontinuous track segments to combine all of the books 2 into a single whole combined book. The difference between the designs of the still another preferred embodiment (FIGS. 8-10) and the foregoing preferred embodiments (FIGS. 1-7) is that two outer cover plates 1 are directly provided on the outermost two sides of the outermost two books 2, respectively, and the outer cover plate 1 can not be separated from the outermost book 2.

The present invention mainly separates pages in a traditional book into a plurality of books 2, and then provides a plurality of mounting elements 3 on edges of each of the books 2, wherein all of the books 2 can be combined into a single whole combined book, while the user can selectively detach some books 2 from the outer cover plate 1 according to the user's desire/needs without always carrying the whole book. For example, the student can only detach and carry some book 2 related to the course on the day without carrying the whole book. Thus, for the student, the loading of carrying too heavy books can be reduced. Meanwhile, the books 2 can be separated according to chapters, paragraphs or difficulty thereof, so that the reader can easily separate and understand the content of the books 2 for selecting a book 2 which the reader wants to carry.

The present invention has been described with a preferred embodiment thereof and it is understood that many changes and modifications to the described embodiment can be carried out without departing from the scope and the spirit of the invention that is intended to be limited only by the appended claims.

1. A detachable book structure, comprising:
an outer cover plate;
a plurality of books disposed in the outer cover plate; and
a plurality of mounting elements provided on an inner side of the outer cover plate and edges of each of the books, respectively;
wherein the edges of each of the books and the inner side of the outer cover plate are provided with the plurality of the mounting elements, so that the outer cover plate is combined with the books by the mounting elements, and the books are stably mounted in the outer cover plate for being selectively detached therefrom according to desire.

2. The detachable book structure according to claim 1, wherein positions of the mounting elements of the outer cover plate are corresponding to that of the mounting elements of the books, so that the books are correctly mounted in the outer cover plate.

3. The detachable book structure according to claim 1, wherein the mounting elements are selected from magnetic elements, riveting buckles or tracks.

4. A detachable book structure, comprising:
a plurality of books, wherein the outermost two sides of the outermost two books is provided with an outer cover plate, respectively; and
a plurality of mounting elements provided on edges of each of the books, respectively;
wherein the books are combined into a whole book by the mounting elements on the edges of each of the books, and the books are selectively detached therefrom according to desire.

5. The detachable book structure according to claim 4, wherein positions of the mounting elements of any two adjacent of the books are corresponding to each other, so that the books are combined into the whole book.

6. The detachable book structure according to claim 4, wherein the mounting elements are selected from magnetic elements, riveting buckles or tracks.
